(19) United States
(12) Patent Application Publication
(10) Pub. No.: US 2026/0313279 A1
(43) Pub. Date: Oct. 8, 2026

(54) EARPHONE

(71) Applicant: Shenzhen Dancing Future Technology Ltd., Shenzhen (CN)

(72) Inventors: Xudong LU, Shenzhen (CN); Zhiyu SUN, Shenzhen (CN); Jianhui HUANG, Shenzhen (CN)

(21) Appl. No.: 19/480,016

(22) PCT Filed: Apr. 28, 2025
(86) PCT No.: PCT/CN2025/091678

§ 371 Date: Oct. 29, 2025

(30) Foreign Application Priority Data
Sep. 30, 2024 (CN) 202411394299.3

(51) Int. Cl. H04R 1/02; H04R 1/10; H04R 1/1025

(52) U.S. Cl. CPC H04R 1/028; H04R 1/1016; H04R 1/1025; H04R 1/1041; H04R 1/105; H04R 2460/13

(57) ABSTRACT

The present disclosure provides an earphone. The earphone includes an earphone head and an ear clip connected to each other and together clamp a helix; in a wearing state, the earphone head is at a front side of an ear and extends toward an ear concha cavity, and the ear clip bypasses a region of the ear wheel opposite to the ear concha cavity, so that an end of the ear clip away from the earphone head is at a rear side of the ear; the earphone head includes a first housing, a photographing hole and a photographing unit, the photographing hole is in the first housing and communicates with an inner cavity of the first housing; and the photographing unit is in the first housing, and the photographing unit is configured to acquire an image and/or a video in an external environment through the photographing hole.

The present disclosure claims priority to Chinese Patent Application No. 202411394299.3, filed with the China National Intellectual Property Administration on Sep. 30, 2024 and entitled “EARPHONE”, which is incorporated herein by reference in its entirety.

### TECHNICAL FIELD

Embodiments of the present disclosure relate to the technical field of wearable devices, and in particular, to an earphone.

### BACKGROUND

An earphone is a device that converts an electrical signal into sound, and has been widely used in people's daily life. The earphone may be used in conjunction with an electronic device such as a mobile phone or a computer. Types of the earphone may include an in-ear type, an over-ear type, a wireless type, a noise-canceling type, and the like. When using the electronic device, a user may connect the earphone to the electronic device, so as to use the earphone to listen to music or make a call.

However, the current earphones have relatively single functions.

### SUMMARY

In view of the above problems, embodiments of the present disclosure provide an earphone, which has a shooting function on the premise of considering the functions of listening to music or making a call, thereby improving the functional diversity of the earphone.

In order to achieve the above objective, the embodiments of the present disclosure provide the following technical solutions.

The embodiments of the present disclosure provide an earphone, including: an earphone head and an ear clip, where the earphone head and the ear clip are connected to each other and together clamp a helix; in a wearing state, the earphone head is located at a front side of an ear and extends toward an ear concha, and the ear clip bypasses a region of the ear wheel opposite to the ear concha, so that an end of the ear clip away from the earphone head is located at a rear side of the ear;

the earphone head includes a first housing, a photographing hole, and a photographing unit, the photographing hole is disposed in the first housing and communicates with an inner cavity of the first housing; and

the photographing unit is disposed in the first housing, and the photographing unit is configured to acquire an image and/or a video in an external environment through the photographing hole.

In a possible implementation, in the wearing state and in a direction of a sagittal axis of a human body, the first housing includes a first wall surface and a second wall surface that are oppositely disposed, the second wall surface faces the ear concha;

the photographing hole is disposed in the first wall surface and penetrates through the first wall surface; and

the photographing unit is disposed on a side of the first wall surface facing the inner cavity of the first housing and located at the photographing hole.

In a possible implementation, the photographing hole is close to a connection region between the first wall surface and the ear clip.

In a possible implementation, the photographing unit has an optical axis; and

in the wearing state of the earphone, an angle between the optical axis and a sagittal plane of the human body ranges from −20° to 5°; and/or an angle between the optical axis and a horizontal plane of the human body ranges from −10° to −35°.

In a possible implementation, the earphone further includes a voice processing unit, which is disposed in the first housing; and

in the wearing state, a region of the first housing opposite to the voice processing unit is in contact with an inner wall of the ear concha, and the voice processing unit is configured to receive a bone-conducted voice signal.

In a possible implementation, the earphone head includes a protruding portion protruding toward the ear concha, the protruding portion and the earphone head encloses a chamber for accommodating the voice processing unit; and

the protruding portion is located in the ear concha and is in contact with the inner wall of the ear concha.

In a possible implementation, a partial region of the first housing protrudes toward the ear concha to form the protruding portion.

In a possible implementation, the earphone further includes a control unit, which is connected to the voice processing unit and the photographing unit, respectively; and

the control unit is configured to form an instruction to control the photographing unit according to a voice signal of the voice processing unit.

In a possible implementation, the ear clip includes a first ear clip and a second ear clip, the first ear clip straddles the helix and connects the earphone head and the second ear clip, and the second ear clip extends along a back contour of the helix and is in contact with an ear back.

In a possible implementation, the first ear clip includes a second housing, and a circuit board is disposed in the second housing; and

the circuit board is connected to the photographing unit and the voice processing unit, respectively.

In a possible implementation, the earphone further includes a touch unit, which is disposed on the circuit board and attached to a wall surface of the second housing away from the ear.

In a possible implementation, the second ear clip includes a third housing, a battery is further disposed in the third housing, and the battery is electrically connected to the circuit board, the photographing unit, and the voice processing unit, respectively.

In a possible implementation, the earphone further includes a sound generating unit, which is disposed on a side of the earphone head facing the ear concha; and

the sound generating unit and the second wall surface of the earphone head are arranged in a stacked manner in a coronal axis direction of the human body.

In a possible implementation, a sound outlet hole is disposed in a wall surface of the first housing opposite to the sound generating unit, and the sound outlet hole communicates with the inner cavity of the first housing.

In the earphone provided by the embodiments of the present disclosure, the earphone head of the earphone includes the first housing, the photographing hole, and the photographing unit, the photographing hole is disposed in the first housing and communicates with the first housing; and the photographing unit is disposed in the first housing, and the photographing unit is configured to acquire the image and/or the video in the external environment through the photographing hole. In this way, the earphone can have the shooting function on the premise of considering the functions of listening to music or making a call, thereby improving the functional diversity of the earphone.

In addition to the technical problems solved by the embodiments of the present disclosure, the technical features constituting the technical solutions, and the beneficial effects brought by the technical features of these technical solutions as described above, other technical problems that can be solved by the earphone provided by the embodiments of the present disclosure, other technical features included in the technical solutions, and the beneficial effects brought by these technical features will be further described in detail in the detailed description.

### BRIEF DESCRIPTION OF DRAWINGS

In order to more clearly describe the technical solutions in the embodiments of the present disclosure or in the prior art, the following briefly introduces the drawings that need to be used in the description of the embodiments or the prior art. Obviously, the drawings in the following description are some embodiments of the present disclosure, and for those of ordinary skill in the art, other drawings may also be obtained from these drawings without creative efforts.

FIG. 1 is a first schematic diagram of an ear provided by an embodiment of the present disclosure;

FIG. 2 is a second schematic diagram of an ear provided by an embodiment of the present disclosure;

FIG. 3 is a schematic diagram of an earphone in a wearing state provided by an embodiment of the present disclosure;

FIG. 4 is a first schematic diagram of an earphone provided by an embodiment of the present disclosure;

FIG. 5 is a second schematic diagram of an earphone provided by an embodiment of the present disclosure; and

FIG. 6 is a schematic diagram of control of an earphone provided by an embodiment of the present disclosure.

### Description of Reference Numerals in the Drawings

100: earphone;
110: earphone head; 111: first housing; 1111: first wall surface; 1112: second wall surface; 112: photographing hole; 113: photographing unit; 114: protruding portion;
120: ear clip; 121: first ear clip; 122: second ear clip;
130: voice processing unit;
140: circuit board;
150: battery;
160: sound generating unit;
170: touch unit;
180: control unit;
200: ear; 210: helix; 220: ear concha; 221: ear concha cavity; 222: ear concha cymba; 230: tragus; 240: antitragus; 250: anti-helix; 251: superior crus of anti-helix; 252: inferior crus of anti-helix; 260: triangular fossa; 270: crus of helix; 280: external acoustic meatus; 290: earlobe.

### DETAILED DESCRIPTION

An earphone is a device that converts an electrical signal into sound, and is commonly used for personal audio listening or making a call. Specifically, the earphone receives an electrical signal from a media player or a receiver and converts it into audible sound waves using a speaker close to the ear. However, it has a problem of relatively single function.

In view of the above technical problem, embodiments of the present disclosure provide an earphone. An earphone head of the earphone includes a first housing, a photographing hole, and a photographing unit, the photographing hole is disposed in the first housing and communicates with the first housing; and the photographing unit is disposed in the first housing, and the photographing unit is configured to acquire an image and/or a video in an external environment through the photographing hole. In this way, the earphone can have a shooting function on the premise of considering the functions of listening to music or making a call, thereby improving the functional diversity of the earphone.

In order to make the above objectives, features, and advantages of the embodiments of the present disclosure more comprehensible, the technical solutions in the embodiments of the present disclosure will be described clearly and completely with reference to the drawings in the embodiments of the present disclosure. Obviously, the described embodiments are only some embodiments of the present disclosure, rather than all the embodiments. All other embodiments obtained by those of ordinary skill in the art based on the embodiments of the present disclosure without creative efforts belong to the protection scope of the present disclosure.

An embodiment of the present disclosure provides an earphone 100, which may be an in-ear earphone, a semi-in-ear earphone, a bone conduction earphone, a wireless earphone, etc. The following describes the embodiments of the present disclosure by taking a wireless earphone as an example.

In order to clearly describe the structure of the earphone provided by the present disclosure, the following will describe the structure of the ear and the definitions of the wearing state, the front side, the rear side, the upper side, the lower side of the ear, the sagittal plane, the coronal plane, the horizontal plane, the sagittal axis, the coronal axis, the vertical axis of the human body, and the X, Y, Z directions involved in the text.

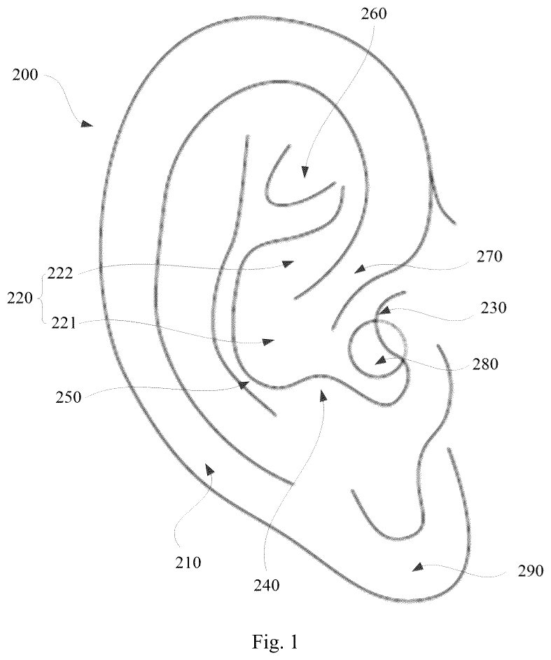

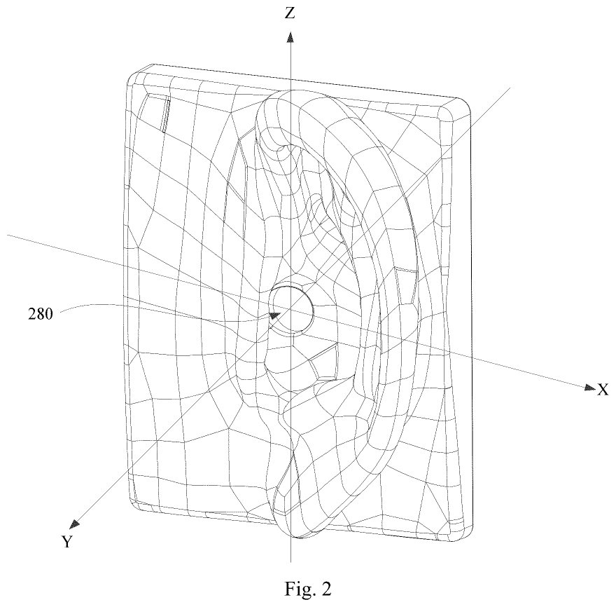

Referring to FIG. 1 and FIG. 2, a user's ear 200 includes a structure such as a helix 210, an ear concha 220, a tragus 230, an antitragus 240, an anti-helix 250, a superior crus of anti-helix 251, an inferior crus of anti-helix 252, a triangular fossa 260, a crus of helix 270, an external acoustic meatus 280, and an earlobe 290. The ear concha 220 may include an ear concha cymba 222 and an ear concha cavity 221.

The front side and the rear side of the ear are defined as follows. The “front side of the ear” described in the present disclosure is a concept relative to the “rear side of the ear”, the former refers to a side of the ear away from the head, and the latter refers to a side of the ear toward the head.

The sagittal plane, the coronal plane, the horizontal plane, the sagittal axis, the coronal axis, and the vertical axis of the human body are defined as follows. As is well known in the fields of medicine, anatomy, etc., three basic sections of the human body, namely a sagittal plane (Sagittal Plane), a coronal plane (Coronal Plane), and a horizontal plane (Horizontal Plane), and three basic axes of the human body, namely a sagittal axis (Sagittal Axis), a coronal axis (Coronal Axis), and a vertical axis (Vertical Axis), may be defined. The sagittal plane refers to a section perpendicular to the ground and along a front-back direction of the body, which divides the human body into left and right parts; the coronal plane refers to a section perpendicular to the ground and along a left-right direction of the body, which divides the human body into front and rear parts; and the horizontal plane refers to a section parallel to the ground and along an upper-lower direction of the body, which divides the human body into upper and lower parts. Correspondingly, the sagittal axis refers to an axis perpendicular to the coronal plane and along the front-back direction of the body, the coronal axis refers to an axis perpendicular to the sagittal plane and along the left-right direction of the body, and the vertical axis refers to an axis perpendicular to the horizontal plane and along the upper-lower direction of the body. A direction parallel to the sagittal axis is an X direction; a direction pointing to an outer side of the ear and parallel to the coronal axis is defined as a Y direction; and a direction parallel to the vertical axis is a Z direction.

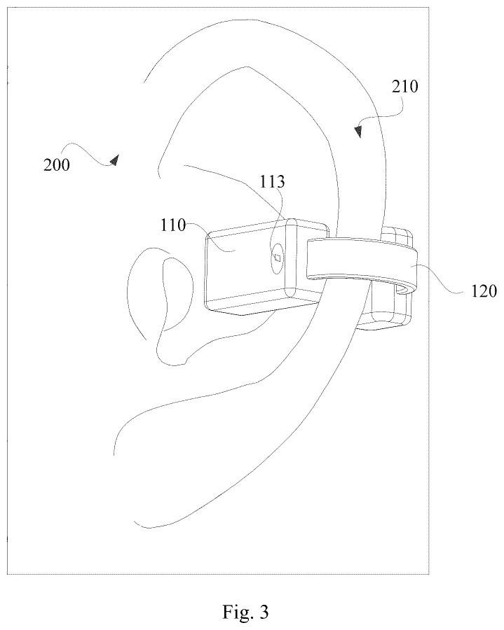

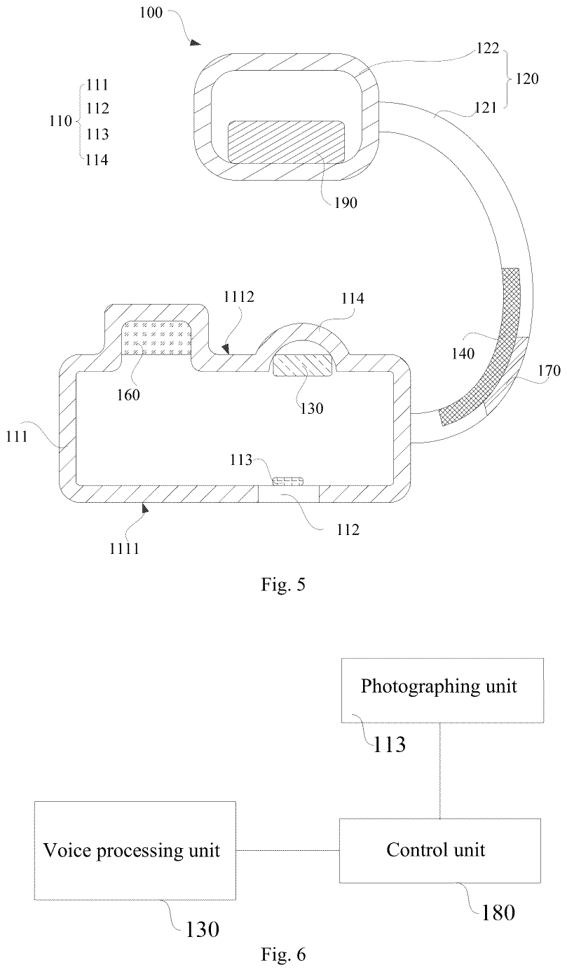

Referring to FIGS. 3 to 5, an earphone 100 provided by an embodiment of the present disclosure includes an earphone head 110 and an ear clip 120, which are connected to each other and together clamp a helix, so that the earphone 100 can be worn on a user's ear.

In a wearing state, the earphone head 110 is located at a front side of the ear 200 and extends toward an ear concha cavity 221, so that a sound generating component of the earphone 100 is close to the ear concha cavity 221, thereby improving the sound quality effect of the earphone. It should be noted that the sound quality effect in this embodiment includes the volume of the earphone and the clarity of the sound quality of the earphone.

The ear clip 120 bypasses a region of the ear wheel 210 opposite to the ear concha cavity 221, so that an end of the ear clip 120 away from the earphone head 110 is located at a rear side of the ear 200. In this way, the earphone 100 in this embodiment is in a form of an ear clip.

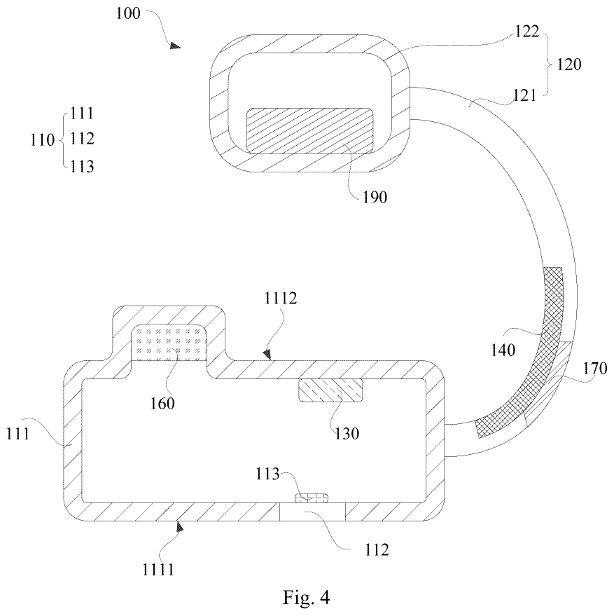

Referring to FIG. 4, the earphone head 110 includes a first housing 111, and an inner cavity of the first housing 111 is used for disposing components of the earphone 100. For example, the inner cavity of the first housing 111 may be used for disposing a sound generating device, a microphone, or other components.

The earphone head 110 further includes a photographing hole 112 and a photographing unit 113, the photographing hole 112 is disposed in the first housing 111 and communicates with the inner cavity of the first housing 111, so that the photographing hole 112 is a through hole penetrating in a thickness direction of the first housing 111. The photographing hole 112 may be circular, square, oval, or in any other shape, which is not limited in this embodiment.

It should be noted that a waterproof and light-transmitting film may further be disposed on the photographing hole 112, so that on the premise that the photographing unit 113 captures clear and bright images and videos, moisture can be effectively prevented from entering the interior of the earphone head 110, thereby protecting the photographing unit 113 and other internal electronic components from moisture damage, and prolonging the service life of the earphone 100.

The photographing unit 113 is disposed in the first housing 111, and the photographing unit 113 is configured to acquire an image and/or a video in an external environment through the photographing hole 112. In this way, the earphone can have a shooting function on the premise of considering the functions of listening to music or making a call, thereby improving the functional diversity of the earphone, and further improving the use flexibility of the earphone. For example, when the user wears the earphone for an outdoor activity, the earphone 100 may use the photographing unit 113 to photograph and record the surrounding environment. The earphone 100 may also interact with an external device based on the surrounding environment photographed by the photographing unit 113, so as to determine the photographed surrounding environment, thereby improving the safety of the user. For another example, when the user wears the earphone in a remote conference, the earphone 100 may capture the user's voice and gesture information, and provide accurate instruction input for AI.

The earphone provided by the embodiments of the present disclosure can be used to acquire a lateral and/or forward image and/or video of the user in the wearing state. In some embodiments, in the wearing state and in a direction of a sagittal axis of the human body, the first housing 111 includes a first wall surface 1111 and a second wall surface 1112 that are oppositely disposed, the second wall surface 1112 faces the ear concha cavity 221; or in other words, in the direction of the sagittal axis of the human body, the first wall surface 1111 is a wall surface facing a front side of the user, and the second wall surface 1112 is a wall surface facing a rear side of the user.

The photographing hole 112 is disposed in the first wall surface 1111 and penetrates through the first wall surface 1111; and the photographing unit 113 is disposed on a side of the first wall surface 1111 facing the inner cavity of the first housing 111 and located at the photographing hole 112. In this way, the earphone can directly capture a region on a front side of the user's face through the photographing hole 112 in the wearing state, thereby acquiring image and/or video information in a sight direction of the user.

In other embodiments, the photographing unit 113 may also be disposed on a side of the second wall surface 1112 facing the inner cavity of the first housing 111 and directly opposite to the photographing hole 112. In this way, the disposition position of the photographing unit 113 may be flexibly adjusted according to the layout of each component in the first housing 111, thereby improving the design flexibility of the earphone 100.

As for the selection of the disposition position of the photographing hole 112 on the first wall surface 1111, it may be as far away from the tragus of the ear 200 as possible, so as to avoid the face region near the tragus from blocking the photographing unit 113. Exemplarily, the photographing hole 112 is close to a connection region between the first wall surface 1111 and the ear clip 120. It should be noted that the connection region in this embodiment may be understood as an interface where the first wall surface 1111 is connected to and in contact with the ear clip 120, and that the photographing hole 112 is close to the connection region between the first wall surface 1111 and the ear clip 120 may take this interface as a boundary, and the photographing hole 112 has a preset distance from the boundary. In this way, on the one hand, the field of view of the photographing unit 113 may be directly aligned with the front side of the user, so as to facilitate the capture of the user's gestures or the environmental information in front of the user, and avoid the user's ear from blocking the camera, and reduce the blind area of the field of view caused by the human face, thereby ensuring the maximization of the photographing range and the image quality of the photographing unit 113. On the other hand, it may also help to optimize the spatial layout in the first housing 111, so that the photographing unit 113 and other components are more compactly integrated in the first housing 111.

In some embodiments, the photographing unit 113 has an optical axis. The optical axis may be understood as an imaginary straight line that is at the center of a lens of the photographing unit 113 and perpendicular to an imaging plane of an image sensor. Or, the optical axis is an axis of symmetry of the photographing unit 113.

In the wearing state of the earphone, an angle between the optical axis and a sagittal plane of the human body ranges from −20° to 5°, and/or an angle between the optical axis and a horizontal plane of the human body ranges from −10° to −35°. Exemplarily, the value of the angle between the optical axis and the sagittal plane of the human body is −20°, −15°, −10°, −5°, 0°, or 5°. The value of the angle between the optical axis and the horizontal plane of the human body is −10°, −15°, −20°, −25°, −30°, or −35°.

In the embodiment, by setting the angle between the optical axis and the sagittal plane of the human body and/or the angle between the optical axis and the horizontal plane of the human body, the photographing angle of the photographing unit 113 can be optimized, making it more in line with the ergonomic design. In this way, when the user wears the earphone 100, the surrounding environment in the sight direction of the user can be captured more naturally, and the photographing blind area of the photographing unit 113 can be reduced as much as possible, thereby ensuring that the photographing unit 113 can cover a wider field of view.

In some embodiments, the earphone 100 further includes a voice processing unit 130, which is disposed in the first housing 111.

In the wearing state, a region of the first housing 111 opposite to the voice processing unit 130 is in contact with an inner wall of the ear concha cavity 221; and based on the fact that sound can use the skull of the head as a transmission medium, the voice processing unit 130 is configured to receive a bone-conducted voice signal. When the user is in a strong noise environment, since the bone-conducted voice signal is less affected by environmental noise, the voice processing unit 130 can pick up the voice signal more clearly and accurately. In this way, the user can communicate with other people in a smaller voice, thereby improving the privacy of the earphone, so that the user can also conduct private voice communication in public or noisy environment.

In addition, the voice processing unit 130 may also cooperate with a microphone of the earphone 100, where the microphone of the earphone 100 receives a voice signal transmitted through air, and the voice processing unit 130 receives a voice signal transmitted through bone conduction. By comparing the above two voice signals, if the two voice signals have high consistency in time and frequency, it may be determined that the user is speaking; otherwise, it may be determined that the user is not speaking. In this case, the microphone may be automatically turned off when the user is not speaking, thereby enhancing the privacy protection of the user, which is particularly important in some sensitive scenarios.

It should be understood that the voice processing unit 130 receives the voice signal transmitted through bone conduction, so the closer the voice processing unit 130 is to the human face, the better. Referring to FIG. 4, exemplarily, the earphone head 110 includes a protruding portion 114 protruding toward the ear concha cavity 221, and the voice processing unit 130 is disposed in a chamber enclosed by the protruding portion 114 and the earphone head 110 for accommodating. For example, a partial region of the first housing 111 protrudes toward the ear concha cavity 221 to form the protruding portion 114, that is, a partial region of the second wall surface 1112 protrudes toward the ear concha cavity 221 to form the protruding portion 114. In this way, the first housing 111 and the protruding portion 114 may be an integral piece, which may simplify the manufacturing process, and reduce the manufacturing cost and the assembly complexity. In addition, the design of the protruding portion 114 may be finely adjusted according to the user's ear contour, so that the earphone is more in line with personal characteristics, thereby enhancing the aesthetics and personalization of wearing. At the same time, this design also provides more design space for the earphone to meet the aesthetic needs of different users.

In the wearing state, the protruding portion 114 is located in the ear concha cavity 221 and is in contact with the inner wall of the ear concha cavity 221. In this way, the voice signal transmitted through bone conduction can be more effectively received, the attenuation and interference of the signal in the transmission process can be reduced, and the clarity and sensitivity of the voice signal can be improved.

In some embodiments, referring to FIG. 6, the earphone 100 further includes a control unit 180, which is connected to the voice processing unit 130 and the photographing unit 113, respectively, and the control unit 180 is configured to form an instruction to control the photographing unit 113 according to a voice signal of the voice processing unit 130.

The photographing unit 113 may take a photo or record a video of the surrounding environment of the user when needed; however, if the photographing unit 113 is always in a turned-on state when this function is not needed, the power consumption of the earphone 100 will be increased, and the standby time of the earphone 100 will be reduced. Therefore, in the embodiment, the linkage between the voice processing unit 130 and the photographing unit 113 may be realized through the control unit 180, and the photographing unit 113 may be controlled to be turned on and turned off through voice, thereby avoiding the continuous operation of the photographing unit 113 when it is not needed, and significantly reducing the overall power consumption of the earphone 100. This intelligent energy-saving mechanism can extend the standby time and continuous use time of the earphone, thereby improving the user experience.

In other embodiments, the image and/or video acquired by the photographing unit 113 need to be transmitted to an external electronic device for processing, for example, to a mobile phone or a computer. Therefore, the earphone provided by the embodiment further includes a communication module, and the photographing unit 113 is connected to the external electronic device through the communication module, thus eliminating the need to rely on Bluetooth to implement the cumbersome steps of connecting a traditional earphone to a smart phone for data transmission, and improving the convenience of use for the user.

In a possible implementation, the ear clip 120 includes a first ear clip 121 and a second ear clip 122, the first ear clip 121 straddles the helix and connects the earphone head 110 and the second ear clip 122, and the second ear clip 122 extends along a back contour of the helix 210 and is in contact with an ear back.

The first ear clip 121 connects the second ear clip 122 and the earphone head 110, so that the earphone 100 forms a U-shaped structure, and the U-shaped earphone 100 has better stability and may fit the user's ear contour more effectively. In particular, when the second ear clip 122 extends along the back contour of the helix and is in contact with the ear back, the wearing stability of the earphone is greatly increased, and the risk of the earphone accidentally falling off during movement or activity is reduced.

The design of the first ear clip 121 also increases the area of a region where the earphone straddles the helix, so that some components of the earphone 100 may be disposed at the first ear clip 121 in a targeted manner, thereby improving the layout compactness of the earphone 100. Exemplarily, the first ear clip 121 includes a second housing, and a circuit board 140 is disposed in the second housing; and the circuit board 140 is connected to the photographing unit 113 and the voice processing unit 130, respectively.

The photographing unit 113 and the voice processing unit 130 are disposed in the first housing 111, and the circuit board 140 is disposed in the second housing adjacent to the first housing 111, so that the distances between the photographing unit 113 and the circuit board 140 and between the voice processing unit 130 and the circuit board 140 are shortened, which helps to shorten the circuit layout between the circuit board 140 and the photographing unit 113 and the circuit layout between the circuit board 140 and the voice processing unit 130, thereby shortening the signal transmission path, reducing signal attenuation and interference, optimizing data transmission efficiency and signal quality, and improving the overall performance of the earphone.

In other embodiments, the second ear clip 122 may be made of a hard material or an elastic material. Exemplarily, the second ear clip 122 is a bracket made of an elastic material. The elastic material may include silica gel, thermoplastic polyurethane (TPU), memory titanium wire, or other materials, so that the user may make adaptive adjustments according to different wearing habits, thereby ensuring that the earphone fits firmly on the user's ear when worn, and reducing the risk of the earphone falling off.

In addition, the second ear clip 122 made of silica gel or thermoplastic polyurethane (TPU) may also provide the user with a buffered and comfortable wearing feel, effectively disperse the pressure of the earphone on the ear, and reduce the discomfort caused by long-term wearing.

In a possible implementation, the earphone 100 further includes a touch unit 170, which is disposed on the circuit board 140 and attached to a wall surface of the second housing away from the ear 200. The addition of the touch unit 170 allows the user to control the earphone 100 through simple touch operations, such as adjusting the volume, switching audio, starting/stopping photographing, etc. Moreover, the touch unit 170 is attached to the wall surface of the second housing away from the ear 200, so that the touch sensitivity of the touch unit 170 can be improved.

In a possible implementation, the second ear clip 122 includes a third housing, a battery 150 is disposed in the third housing, and the battery 150 is electrically connected to the circuit board 140, the photographing unit 113, and the voice processing unit 130, respectively. The battery 150 is used to provide electric energy for the circuit board 140, the photographing unit 113, and the voice processing unit 130, respectively, which helps to ensure the stable operation and optimal performance of each functional module (such as the photographing unit, the voice processing unit, etc.) of the earphone.

It should be noted that the cross-sectional areas of the first ear clip 121 and the second ear clip 122 may be equal everywhere, or there may be other choices. As an example, the cross-sectional area of the second ear clip 122 is larger than the cross-sectional area of the first ear clip 121, so that the second ear clip 122 may provide a larger support area and a stronger clamping force when in contact with the ear back, thereby enhancing the overall wearing stability of the earphone, which helps to reduce the risk of the earphone accidentally falling off when the user is moving or doing activities.

In addition, the disposition of the second ear clip 122 helps to further optimize the weight distribution of the earphone 100. By concentrating part of the weight on the ear back position, the pressure of the earphone on the helix and the ear canal can be reduced, making the wearing more relaxed and natural, which is especially suitable for users who need to wear the earphone for a long time.

In a possible implementation, the earphone 100 further includes a sound generating unit 160, which is disposed on a side of the earphone head 110 facing the ear concha cavity 221; and the sound generating unit 160 and the second wall surface 1112 of the earphone head 110 are arranged in a stacked manner in a coronal axis direction of the human body. In this way, the space utilization rate is effectively improved, and with this design, the overall size of the earphone head 110 and the sound generating unit 160 may be made smaller, which in turn makes the size of the entire earphone smaller, makes the earphone more portable and lighter, and makes it convenient for people with smaller ears to wear, thereby improving the applicability of the earphone.

In addition, the sound generating unit 160 and the second wall surface 1112 of the earphone head 110 are arranged in a stacked manner in the coronal axis direction of the human body, which may also help the sound generating unit 160 to extend into the ear concha cavity 221, thereby making the sound generating unit 160 closer to the external acoustic meatus 280, and improving the sound quality and volume performance of the earphone 100.

In some embodiments, the sound generating unit 160 is disposed in the first housing 111. In this case, a partial region of the second wall surface 1112 of the first housing 111 protrudes toward the ear concha cavity 221, so that the second wall surface 1112 forms an accommodating chamber, and the accommodating chamber and the inner cavity of the first housing 111 are communicated with each other. The sound generating unit 160 is disposed in the accommodating chamber. Since the accommodating chamber is closer to the external acoustic meatus, it may help to promote the natural conduction of audio, reduce attenuation and distortion, and make the audio more real and natural.

In the embodiment, a sound outlet hole is disposed in a wall surface of the first housing 111 opposite to the sound generating unit 160. The sound outlet hole is communicated with the inner cavity of the first housing 111, and the audio formed by the sound generating unit 160 may be transmitted into the external acoustic meatus of the ear through the sound outlet hole.

It should be noted that when the first housing 111 includes the accommodating chamber, the sound outlet hole may be disposed in a bottom wall and/or a side wall of the accommodating chamber. In the embodiment, by skillfully disposing the sound outlet hole at an appropriate position of the first housing (such as the bottom wall or the side wall of the accommodating chamber), it may be ensured that the sound enters the ear canal at an optimal angle and in an optimal manner, thereby reducing the discomfort caused by the sound directly impacting the eardrum.

The embodiments or implementations in the specification are described in a progressive manner, and each embodiment focuses on the differences from other embodiments. For the same and similar parts between the various embodiments, reference may be made to each other.

It should be pointed out that “an embodiment”, “embodiment”, “exemplary embodiment”, “some embodiments”, etc. mentioned in the specification represent that the described embodiments may include specific features, structures or characteristics, but not necessarily each embodiment includes the specific features, structures or characteristics. In addition, such phrases are not necessarily referring to the same embodiment. In addition, when describing specific features, structures or characteristics in combination with embodiments, it is within the knowledge of those skilled in the art to implement such features, structures or characteristics in combination with other embodiments explicitly or not explicitly described.

Finally, it should be noted that the above embodiments are only used to illustrate the technical solutions of the present disclosure, rather than limiting them. Although the present disclosure has been described in detail with reference to the aforementioned embodiments, those of ordinary skill in the art should understand that they may still modify the technical solutions recorded in the aforementioned embodiments, or equivalently replace some or all of technical features, and these modifications or replacements do not make the essence of the corresponding technical solutions depart from the scope of the technical solutions of the embodiments of the present disclosure.

1. An earphone, comprising: an earphone head and an ear clip, wherein the earphone head and the ear clip are connected to each other and together clamp a helix; in a wearing state, the earphone head is located at a front side of an ear and extends toward an ear concha cavity, and the ear clip bypasses a region of the helix opposite to the ear concha cavity, so that an end of the ear clip away from the earphone head is located at a rear side of the ear;
the earphone head comprises a first housing, a photographing hole, and a photographing unit, the photographing hole is disposed in the first housing and communicates with an inner cavity of the first housing; and
the photographing unit is disposed in the first housing, and the photographing unit is configured to acquire an image and/or a video in an external environment through the photographing hole.

2. The earphone of claim 1, wherein in the wearing state and in a direction of a sagittal axis of a human body, the first housing comprises a first wall surface and a second wall surface that are oppositely disposed, the second wall surface faces the ear concha cavity;
the photographing hole is disposed in the first wall surface and penetrates through the first wall surface; and
the photographing unit is disposed on a side of the first wall surface facing the inner cavity of the first housing and located at the photographing hole.

3. The earphone of claim 2, wherein the photographing hole is close to a connection region between the first wall surface and the ear clip.

4. The earphone of claim 1, wherein the photographing unit has an optical axis; and
in the wearing state of the earphone, an angle between the optical axis and a sagittal plane of the human body ranges from −20° to 5°, and/or an angle between the optical axis and a horizontal plane of the human body ranges from −10° to −35°.

5. The earphone of claim 1, wherein the earphone further comprises a voice processing unit, and the voice processing unit is disposed in the first housing; and
in the wearing state, a region of the first housing opposite to the voice processing unit is in contact with an inner wall of the ear concha cavity, and the voice processing unit is configured to receive a bone-conducted voice signal.

6. The earphone of claim 5, wherein the earphone head comprises a protruding portion protruding toward the ear concha cavity, the protruding portion and the earphone head encloses a chamber for accommodating the voice processing unit; and
the protruding portion is located in the ear concha cavity and is in contact with the inner wall of the ear concha cavity.

7. The earphone of claim 6, wherein a partial region of the first housing protrudes toward the ear concha cavity to form the protruding portion.

8. The earphone of claim 5, wherein the earphone further comprises a control unit, and the control unit is connected to the voice processing unit and the photographing unit, respectively; and
the control unit is configured to form an instruction to control the photographing unit according to a voice signal of the voice processing unit.

9. The earphone of claim 5, wherein the ear clip comprises a first ear clip and a second ear clip, the first ear clip straddles the helix and connects the earphone head and the second ear clip, and the second ear clip extends along a back contour of the helix and is in contact with an ear back.

10. The earphone of claim 9, wherein the first ear clip comprises a second housing, and a circuit board is disposed in the second housing; and
the circuit board is connected to the photographing unit and the voice processing unit, respectively.

11. The earphone of claim 10, wherein the earphone further comprises a touch unit, the touch unit is disposed on the circuit board and attached to a wall surface of the second housing away from the ear.

12. The earphone of claim 10, wherein the second ear clip comprises a third housing, a battery is further disposed in the third housing, and the battery is electrically connected to the circuit board, the photographing unit, and the voice processing unit, respectively.

13. The earphone of claim 1, wherein the earphone further comprises a sound generating unit, and the sound generating unit is disposed on a side of the earphone head facing the ear concha cavity; and
the sound generating unit and a second wall surface of the earphone head are arranged in a stacked manner in a coronal axis direction of the human body.

14. The earphone of claim 13, wherein a sound outlet hole is disposed in a wall surface of the first housing opposite to the sound generating unit, and the sound outlet hole communicates with the inner cavity of the first housing.

15. The earphone of claim 2, wherein the photographing unit has an optical axis; and
in the wearing state of the earphone, an angle between the optical axis and a sagittal plane of the human body ranges from −20° to 5°, and/or an angle between the optical axis and a horizontal plane of the human body ranges from −10° to −35°.

16. The earphone of claim 3, wherein the photographing unit has an optical axis; and
in the wearing state of the earphone, an angle between the optical axis and a sagittal plane of the human body ranges from −20° to 5°, and/or an angle between the optical axis and a horizontal plane of the human body ranges from −10° to −35°.

17. The earphone of claim 2, wherein the earphone further comprises a voice processing unit, and the voice processing unit is disposed in the first housing; and
in the wearing state, a region of the first housing opposite to the voice processing unit is in contact with an inner wall of the ear concha cavity, and the voice processing unit is configured to receive a bone-conducted voice signal.

18. The earphone of claim 3, wherein the earphone further comprises a voice processing unit, and the voice processing unit is disposed in the first housing; and
in the wearing state, a region of the first housing opposite to the voice processing unit is in contact with an inner wall of the ear concha cavity, and the voice processing unit is configured to receive a bone-conducted voice signal.

19. The earphone of claim 2, wherein the earphone further comprises a sound generating unit, and the sound generating unit is disposed on a side of the earphone head facing the ear concha cavity; and
the sound generating unit and a second wall surface of the earphone head are arranged in a stacked manner in a coronal axis direction of the human body.

20. The earphone of claim 3, wherein the earphone further comprises a sound generating unit, and the sound generating unit is disposed on a side of the earphone head facing the ear concha cavity; and
the sound generating unit and a second wall surface of the earphone head are arranged in a stacked manner in a coronal axis direction of the human body.
